(19) United States
(12) Patent Application Publication
(10) Pub. No.: US 2003/0034894 A1
(43) Pub. Date: Feb. 20, 2003

(54) Electronic monitoring system

(75) Inventor: James G. Montagnino, St. Charles, IL (US)

Correspondence Address: ROCKEY, MILNAMOW & KATZ, LTD., TWO PRUDENTIAL PLAZA, STE. 4700, 180 NORTH STETSON AVENUE, CHICAGO, IL, 60601, US

(73) Assignee: BRK Brands, Inc..

(21) Appl. No.: 09/931,421

(22) Filed: Aug. 16, 2001

(51) Int. Cl. G08B 23/00

(52) U.S. Cl. 340/573.4; 340/995; 340/825.49

(57) ABSTRACT

A monitoring system has a monitoring unit and a monitored unit. The monitored unit automatically emits RF signals detectable by the monitoring unit. The monitoring unit includes analysis circuitry for providing at least directional information indicative of the location of the monitored unit with respect to the monitoring unit.

### FIELD OF THE INVENTION

The invention pertains to monitoring devices. More particularly, the invention pertains to devices usable to monitor the location of individuals such as children or those in need of assistance.

### BACKGROUND OF THE INVENTION

A variety of products have been developed to enable parents to keep track of the location of one or more children when out of the house or car, such as in stores, malls, sports areas or the like. One type of product is a leash which connects a parent to a child. The leash makes is possible for the parent to keep a child relatively close for safety and supervision. Such products tend to be suitable only for relatively young children.

Another type of product is a pair of walkie-talkies. A parent has one unit, the child has a second unit. The parent can be in audio contact with the child and vice versa. While these types of products enable the child to roam freely of the parent, they only provide location information that the child can convey. Such types of products do not provide child independent information as to the location of the child relative to the parent. If a child becomes separated or lost, it may not be able to inform the parent as to where it is.

There continues to be a need for monitoring devices which provide more freedom to a child than a leash but at the same time can provide location information easily and automatically as does a leash. Preferably such products would be light weight and unobtrusive in use as well as relatively inexpensive. It would also be desirable if they could enable a parent to give verbal directions to the child as needed.

### SUMMARY OF THE INVENTION

An electronic monitoring system includes a primary unit which is in wireless communication with a secondary unit. The primary unit is worn or carried by a supervising person. The secondary unit is worn or carried by the person whose condition or location is being monitored.

The primary unit can be configured like a wristwatch to be worn by the supervising person. Preferably it would have a display which could present location and distance information concerning a person wearing or carrying a secondary unit. In one embodiment, one of several secondary units, being simultaneously tracked, could be selected for display.

By automatically providing location and direction information, the supervising person can move toward and find someone who has wondered off or become lost. Since the secondary units communicate automatically wirelessly with the primary unit, the person being supervised does not need to be able to supply such information.

Preferably, the primary unit will also incorporate a wireless audio link, receivable by the secondary units. This embodiment provides direct audio communication between the supervising person and the persons carrying the secondary units.

In one embodiment, the secondary units can be configured like wristwatches or, ankle bracelets. Each secondary unit can include a microphone/speaker combination and a transceiver for wireless, bidirectional, audio communication with a supervising person.

A child's unit can also carry a panic or emergency button thereby enabling the child to signal the primary unit, without audio, that help is needed. The supervising person can then initiate audio communication, and, using the automatically generated distance and direction information to locate the child.

Preferably, the primary unit will include a transceiver with an output coupled to signal analysis circuitry to establish distance and location information relative to one or more secondary units. A switch can be provided for selection of a secondary unit.

Another embodiment can be directed to the needs of adults or older children whose location, due to a physiological condition, needs to be monitored. Such units could be alternately combined with a decorated wrist band or necklace so as to be user acceptable.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1 is an over-all diagram of a system in accordance with the present invention;

FIG. 2 is a block diagram of one unit of the system of FIG. 1; and

FIG. 3 is a block diagram of another unit of the system of FIG. 1.

### DETAILED DESCRIPTION OF THE PREFERRED EMBODIMENTS

While this invention is susceptible of embodiment in many different forms, there are shown in the drawing and will be described herein in detail specific embodiments thereof with the understanding that the present disclosure is to be considered as an exemplification of the principles of the invention and is not intended to limit the invention to the specific embodiments illustrated.

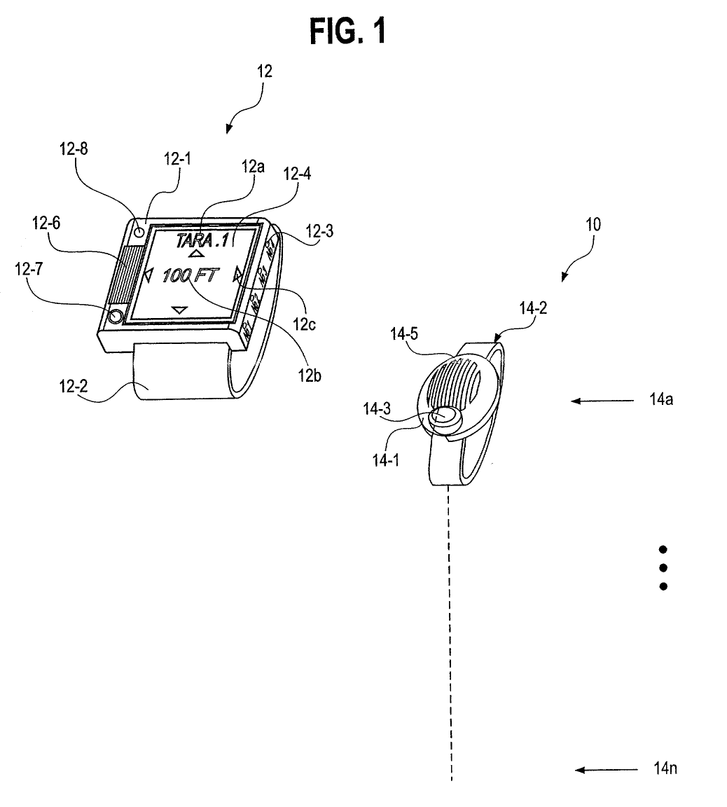

FIG. 1 illustrates a system 10 which has a primary, or supervisory, unit 12 and one or more secondary units 14a, b . . . n. The primary unit is self-contained and has a housing 12-1 with an attached wrist strap 12-2. The exact form of attachment is not a limitation of the invention.

The housing 12-1 contains electronics and a power supply discussed subsequently. It carries a secondary unit selector 12-3 and a display 12-4 upon which can be presented a name 12a associated with a selected secondary unit, such as 14a, indicated as “TARA”. Distance 12b and direction information 12c are also presented on display 12-4.

A microphone 12-5 and speaker 12-6 are available for audio communication with the selected secondary unit 14i. A button 12-7 is available for transmitting pre-stored audio messages to unit 14i. An LED 12-8 can be used to indicate status information such as “out of range”, or, “communication ok”.

The secondary units 14a . . . n are substantially identical so a discussion of a representative unit 14a will also describe each of the other units 14b, c . . . n. The unit 14a is self-contained in a housing 14-1. A wrist or ankle strap 14-2 can be used to attach the unit 14a to a person whose location is being monitored. Other forms of attachment come within the scope of the invention.

The housing 14-1 carries a “panic” or “assistance needed” button or lever 14-3. The element 14-3 can be used to initiate non-verbal communication with primary unit 12. Housing 14-1 also carries a microphone 14-4 and a speaker 14-5 for carrying out audio communication with the primary unit.

In operation, a supervising person, such as a parent, wears primary unit 12. A child or other person being monitored wears unit 14a. Assuming that the supervising person has selected unit 14a, via switch 12-3, an appropriate designator such as 12a, distance parameter 12b and direction indicator 12c will be displayed.

A pre-stored message can be transmitted to unit 14a via message button 12-7. In addition, the supervising person can initiate audio communication with the supervised person wearing unit 14a.

The supervised person wearing unit 14a can respond verbally to received pre-stored messages or real-time audio from unit 12 using the local microphone 14-4 and speaker 14-5. Additionally, the panic switch 14-3 enables the supervised person, to easily alert the supervising person to the existence of an emergency.

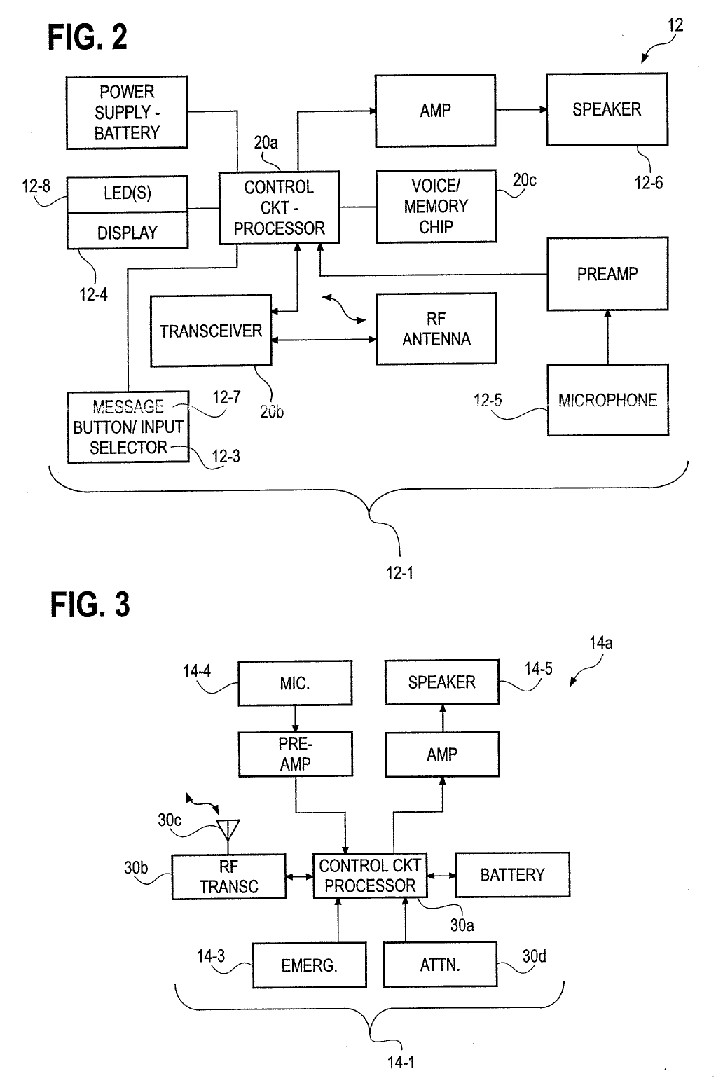

FIG. 2 is an exemplary block diagram of primary unit 12. Control circuitry, such as a programmed processor 20a is coupled to and drives display 12-4 and LED 12-8. More than one LED could be provided. The type of display is not a limitation of the invention.

The processor 20a is in bidirectional communication with transceiver 20b and voice storage/synthesizing circuitry 20c. Circuitry 20c includes a plurality of pre-stored messages that can be transmitted to unit 14a in analog or digital form.

The supervising person can communicate via microphone 12-5 to unit 14a in real-time to make inquiries or to provide directions to the supervised person wearing unit 14a. Other circuit elements of unit 12 will be understood by those of skill in the art and no further discussion of them is necessary.

FIG. 3 is a block diagram of a secondary unit, such as unit 14a. Other secondary units 14b . . . n are substantially identical. Control circuitry, such as processor 30a, is in bidirectional communication with transceiver 30b. The transceiver 30b implements bidirectional RF communication, via antenna 30c, with unit 12. Using the local microphone 14-4 and speaker 14-5, a person wearing unit 14a can verbally communicate with unit 12.

In addition, transceiver 30b automatically provides signals to unit 12, intermittently or continuously, so that unit 12 can generate updated distance and location information for display 12-4. Alternately, the unit 12 can issue RF commands to the units 14a, b . . . n to cause them to transmit updated location and/or distance information without intervention by the person being monitored.

Unit 14a can be provided with a second, non-emergency communication button or switch 30d. Switch 30d is useful where a plurality of units 14b, c, d are active and the supervising person, via unit 12 needs to prioritize communications from the units 12.

It will be understood that secondary units 14a, b . . . n could be worn by children being supervised. Alternately, the secondary units could be worn by adults in need of supervision.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed:

1. A locating device carryable by a person comprising:
a housing with an apparatus for coupling to a person;
a direction indicating display carried by the housing;
at least an RF receiver carried by the housing;
control circuits coupled to the display and the receiver for determining a direction to a source of received signals relative to the receiver, and
including circuits for activating the display responsive to the determined direction.

2. A device as in claim 1 which includes circuits for establishing a distance to the source of received signals.

3. A device as in claim 1 which includes an RF transmitter and circuitry for initiating an inquiry transmission to the source.

4. A device as in claim 3 which includes a manually activatable control element for initiating the inquiry transmission.

5. A device as in claim 4 which includes a second housing, independent of the first housing, wherein the second housing carries the transceiver, the circuitry for initiating an inquiring transmission, the manually activatable control element, and a second apparatus for coupling to a person.

6. A device as in claim 5 wherein each of the apparatus and the second apparatus comprise an appendage strap.

7. A device as in claim 1 wherein the apparatus comprises an appendage strap.

8. A device as in claim 1 which includes a second housing attachable to an individual whose location is to be ascertained.

9. A device as in claim 8 wherein the second housing carries the source of signals received at the housing.

10. A device as in claim 9 wherein the second housing carries at least an audio output device.

11. A device as in claim 10 wherein the second housing carries an audible input transducer.

12. A device as in claim 9 wherein the second housing carries a receiver of wireless signals from the housing.

13. A device as in claim 12 wherein the housing carries an RF transmitter, coupled to the control circuit, for transmission of selected signals to the receiver.

14. A device as in claim 13 wherein the apparatus comprises one of a wrist strap or an attachment clip.

15. A monitoring system comprising:
a first unit carryable by a person to carry out a monitoring function wherein the first unit includes a direction indicating display and a display indicating distance to a second, displaced unit wherein the first unit is responsive to the second unit, wherein the second unit includes at least a wireless transmitter for emitting signals to which the first unit responds by indicating the direction of the second unit, relative to the first and the distance therebetween,

16. A monitoring system as in claim 15 wherein the first unit carries an audio input transducer for receipt of an audible message to be transmitted to the second unit.

17. A monitoring system as in claim 15 wherein the first unit carries a manually operable, monitored person selecting element.

18. A monitoring system as in clam 15 wherein the second unit includes circuitry for emitting an identifier signal to the first unit.

19. A monitoring system as in claim 18 wherein the first unit includes circuitry for distinguishing between identifier signals emitted by a plurality of displaced units.

20. A monitoring system comprising:
a self-contained, portable, monitoring unit having a housing wherein the hosing carries control circuitry, and, at least a wireless receiver wherein the control circuitry includes executable instructions which at least in part, establish a direction to a selected source of wireless signals; and
a self-contained, portable, selected source of wireless signals that can be attached to a second user, the source has a second housing which carries at least a wireless transmitter of direction indicating wireless signals whereby the transmitter, at least intermittently, outputs direction indicating wireless signals of a type to which the receiver and executable instructions respond.

21. A system as in clam 20 wherein the unit includes at least one direction indicating visual output device coupled to the control circuitry.

22. A system as in claim 20 wherein the monitoring unit includes circuitry for establishing a parameter indicative of distance between the unit and the source.

23. A system as in claim 22 wherein the unit includes at least one direction and distance indicating visual output device.

24. A system as in claim 23 wherein the unit includes circuits for wirelessly transmitting signals to the source.

25. A system as in claim 24 wherein the source includes a manually operable member coupled to the transmitter for initiating an assistance seeking transmission.

26. A system as in claim 25 wherein the unit includes executable instructions, responsive to a received assistance seeking transmission, for providing an indication thereof at the housing.

27. A system as in claim 25 wherein the unit includes a microphone for communication of an audio input to the source.

28. A system as in claim 27 wherein the unit and the source each include a coupling member for attaching same to a respective user.
